(19) United States
(12) Patent Application Publication
(10) Pub. No.: US 2024/0199139 A1
(43) Pub. Date: Jun. 20, 2024

(54) GLIDER AND SUPPORT PLATE FOR ACCESSORY ATTACHMENT TO FLOOR TRACK

(71) Applicant: The Braun Corporation, Winamac, IN (US)

(72) Inventors: Justin M. Kline, Westfield, IN (US); Adam Smith, Indianapolis, IN (US)

(21) Appl. No.: 18/538,707

(22) Filed: Dec. 13, 2023

Related U.S. Application Data
(60) Provisional application No. 63/433,210, filed on Dec. 16, 2022.

(51) Int. Cl. B62D 25/20

(52) U.S. Cl. CPC B62D 25/2054

(57) ABSTRACT

A track fitting is provided for securing items to a track in a vehicle. The track fitting may be comprised of multiple pieces that can be independently inserted top-down into the track at any location along the length of the track. The item can then be bolted into the track fitting. The track fitting, in some embodiments, is not dependent upon scalloped track for securement. In other embodiments, the track fitting includes a locking member that creates interference between the track fitting and the scallops to prevent the track fitting from sliding longitudinally in the track.

### CROSS REFERENCE TO RELATED APPLICATIONS

This application claims priority to U.S. Provisional Patent Application No. 63/433,210, filed on Dec. 16, 2022, the contents of which is incorporated herein by reference. This application also incorporates by reference the contents of PCT Patent Application No. PCT/US23/PCT/US23/83845.

### FIELD OF THE DISCLOSURE

The present disclosure relates generally to a passenger vehicle that has been modified to allow access by a physically limited passenger, and more particularly to structures and fittings adapted for and methods for removably engaging various structures—including but not limited to wheelchair lifts, wheelchair ramps, wheelchair securements, occupant restraints, and seat supports—with a track in a vehicle.

### BACKGROUND

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by installing parts specifically designed to accommodate the physically limited passenger.

For instance, vehicles are often retrofitted to include longitudinally- or laterally-extending tracks in or on the floor that are configured to receive, engage with, and support various structures, such as wheelchair tiedown and occupant restraint systems (WTORS) and seats. The tracks permit flexible arrangement and easy installation and removal of those structures anywhere along the length of the tracks. One of the most widely used track is referred to in the industry as L-track. In another known configuration, a van can be retrofitted to include an extruded aluminum floor that is installed on top of the OEM floor. The aluminum floor includes integrated tracks having a similar profile as L-track for mounting WTORS and seats. In any of these configurations, the van will also typically be retrofitted with a wheelchair lift or other vehicle access device, such as a ramp, to enable a physically limited individual using a wheelchair to enter and exit the vehicle. Due to the high cantilever loads to which they are subjected and the fact that they do not need to be moved from one location to another in regular practice, wheelchair lifts are solidly bolted through the vehicle floor (including the aluminum floor, if present) to the vehicle sub-structure.

### SUMMARY OF THE EMBODIMENTS

The prior art bolting method has limitations, including the need to drill holes through the vehicle floor. Various new embodiments of a glider and a support plate are contemplated that solve those limitations by allowing a wheelchair lift, or any other structure, to be mounted to and their load to be properly distributed to tracks, which embodiments comprise combinations of any one or more of the following features or other features described elsewhere in this disclosure.

In one implementation of the present disclosure, a first track fitting is provided for securing an item to a track, where the track is defined by a channel having a first undercut and a second undercut on opposite sides of a top opening. The track fitting may include a first fitting member having a first flange and a first face on opposite sides thereof, and a first partial hole on the first face. The track fitting may also include a second fitting member having a second flange and a second face on opposite sides thereof, and a second partial hole on the second face.

In one version of the first track fitting, the first fitting member and second fitting member are each configured for independent top down insertion into the channel through the top opening, whereby the first flange can be inserted in the first undercut, the second flange can be inserted in the second undercut, and the first face can be disposed adjacent and generally parallel to the second face. When the first face is aligned adjacent and generally parallel to the second face, the first partial hole and the second partial hole define a substantially complete hole for receiving a fastener.

In another version of the first track fitting, the fastener is a threaded fastener and the first partial hole and the second partial hole comprise a pair of threaded partial holes that are configured to receive the threaded fastener when aligned.

In another version of the first track fitting, the first fitting member comprises a plurality of first partial holes spaced along a length of the first fitting member, the second fitting member comprises a plurality of second partial holes spaced along a length of the second fitting member, and the plurality of first partial holes and the plurality of second partial holes define a plurality of substantially complete holes for receiving a plurality of fasteners when the first face is aligned adjacent and generally parallel to the second face.

In another version of the first track fitting, the first flange is disposed along an entire length of the first fitting member and the second flange is disposed along an entire length of the second fitting member.

In another version of the first track fitting, a frangible connector is provided to connect the first fitting member to the second fitting member with the first face aligned adjacent and generally parallel to the second face.

In another version of the first track fitting, the frangible connector comprises one of an adhesive, a weld, and a tape.

In another version of the first track fitting, the frangible connector is formed integral with the first fitting member and the second fitting member.

In another version of the first track fitting, the first partial hole has an axis that is generally parallel to the first face and generally transverse to a longitudinal direction of the track fitting. Additionally, the second partial hole has an axis that is generally parallel to the second face and generally transverse to a longitudinal direction of the track fitting.

In another version of the first track fitting, a locking member is provided. Further, the top opening may be defined by a pair of opposing lips each having a plurality of scallops. Further yet, a first portion of the locking member may engage an opposing pair of the plurality of scallops and a second portion of the locking member may engage with at least one of the first fitting member and the second fitting member to prevent the at least one of the first fitting member and the second fitting member from moving in a longitudinal direction relative to the track.

In another version of the first track fitting, the first flange includes an upper flange portion and a lower flange portion for engagement on opposite sides of an inwardly directed projection in a side wall of the first undercut of the track, wherein the upper flange portion is received in an upper undercut region while the lower flange portion is received in a lower undercut region.

One method for using any version of the first track fitting includes the steps of: inserting the first fitting member in the channel through the top opening; sliding the first fitting member in a first lateral direction whereby the first flange is disposed in the first undercut; inserting the second fitting member in the channel through the top opening, whereby the second fitting member is laterally displaced from the first fitting member; sliding the second fitting member in a second lateral direction whereby the second flange is disposed in the second undercut, the second lateral direction being opposite of the first lateral direction; sliding one or both of the first fitting member and the second fitting member until the first face is adjacent the second face and the first partial hole is aligned with the second partial hole, whereby the first partial hole and the second partial hole for a substantially complete hole; and, inserting a fastener into the substantially complete hole.

One method for manufacturing any version the first track fitting includes the steps of: providing the first fitting member and the second fitting member without the first partial hole and the second partial hole; fixing the first fitting member to the second fitting member with the first face adjacent the second face; and, drilling a hole in a top surface of the first fitting member and the second fitting member to simultaneously form the first partial hole in the first fitting member and the second partial hole in the second fitting member.

The method for manufacturing the first track fitting can also include the step of threading the hole while the first fitting member is still fixed to the second fitting member.

In another implementation of the present disclosure, a second track fitting is provided for securing an item to a track, where the track is defined by a channel having a first undercut and a second undercut on opposite sides of a top opening. Further, the top opening of the track may be defined by a pair of opposing lips each having a plurality of scallops. The track fitting can include at least one fitting member and a locking member. The at least one fitting member is configured for insertion into the channel and engagement with at least one of the first undercut and the second undercut. The at least one fitting member has an interface on a top surface for receiving and engaging with a locking member, whereby the interface is configured to prevent the at least one fitting member from moving in a longitudinal direction relative to the locking member. When the at least one fitting member is inserted in the channel, the locking member is configured for receipt and engagement between an opposing pair of the plurality of scallops, whereby the opposing pair of the plurality of scallops prevents the locking member, and thereby the at least one fitting member, from moving in a longitudinal direction relative to the track.

In one version of the second track fitting, the interface comprises at least one shoulder defining a recessed area in a top surface of the at least one fitting member, whereby the at least one shoulder engages with a perimeter of locking member to prevent the at least one fitting member from moving in the longitudinal direction relative to the track.

In another version of the second track fitting, the interface comprises a bore in a top surface of the at least one fitting member, whereby the bore engages with a stud depending from the locking member to prevent the at least one fitting member from moving in the longitudinal direction relative to the track.

In another version of the second track fitting, the bore is disposed generally central to the recessed area.

In another version of the second track fitting, the bore and the stud are threaded.

In another version of the second track fitting, the locking member comprises a cylinder received between the opposing pair of scallops.

In another version of the second track fitting, the at least one fitting member comprises a unitary fitting member having a first flange opposite a second flange, the first flange for receipt in the first undercut and the second flange for receipt in the second undercut.

In yet another implementation of the present disclosure, a third track fitting is provided for securing an item to a track, the track being defined by a channel having a first undercut and a second undercut on opposite sides of a top opening. The third track fitting may include a fitting member having a first flange and a second flange on opposite sides thereof, wherein: the first flange includes an upper flange portion and a lower flange portion for engagement on opposite sides of an inwardly directed projection in a side wall of the first undercut of the track, wherein the upper flange portion is received in an upper undercut region while the lower flange portion is received in a lower undercut region of the first undercut; and, the second flange includes an upper flange portion and a lower flange portion for engagement on opposite sides of an inwardly directed projection in a side wall of the second undercut of the track, wherein the upper flange portion is received in an upper undercut region while the lower flange portion is received in a lower undercut region of the second undercut.

In yet another implementation of the present disclosure, a support plate assembly may be provided for supporting a wheelchair access device in a vehicle having a plurality of tracks. The support plate assembly may include at least one support plate including at least one connector for lockingly engaging with the wheelchair access device and at least one track fitting adapted for receipt in the track. The at least one support plate may be lockingly engageable with at least one track fitting to collectively secure the wheelchair access device to the track.

In one version of the support plate assembly, at least one support plate and at least one track fitting are configured to secure the wheelchair access device to the track without bolting the wheelchair access device through a floor of the vehicle.

In another version of the support plate assembly, a plurality of fasteners are provided, wherein the at least one support plate includes a plurality of apertures. Additionally, a first set of the plurality of apertures may be positioned to secure the support plate assembly and the wheelchair access device adjacent a rear entry door of the vehicle, while a second set of the plurality of apertures may be positioned to secure the support plate assembly and the wheelchair access device adjacent a side door of the vehicle. In some embodiments, the first set and the second set are different.

One method for using any version of the support plate assembly can include the steps of: providing a first support plate for installation in a first vehicle; securing the first support plate adjacent the rear door of the first vehicle the using the first set of the plurality of apertures; providing a second support plate for installation in a second vehicle; and securing the second support plate adjacent the side door of the second vehicle using the second set of the plurality of apertures.

In another version of the support plate assembly, the support plate may include at least two rows each including a plurality of apertures. The two rows may be spaced apart a distance corresponding to a distance between a first pair of the tracks. Additionally, within each of the two rows, at least two of the plurality of apertures may be spaced apart a distance corresponding to a distance between a second pair of the tracks. In that respect, the support plate can be secured to either the first pair of the tracks with the two rows oriented in a longitudinal direction or the second pair of the tracks with the two rows oriented in a lateral direction.

In another version of the support plate assembly, the support plate includes at least one upwardly extending stud adapted to mate with an aperture on the wheelchair access device and engage with a fastener to secure the wheelchair access device to the track.

In yet another implementation of the present disclosure, any of version of the track fitting may be used in combination with any version of the support plate assembly.

In yet another implementation of the present disclosure, any version of the track fitting, any version of the support plate, or any combination of track fitting and support plate may be used in combination with the vehicle.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a wheelchair lift secured to a plurality of tracks in a vehicle at a rear entrance thereof;

FIG. 2 is a perspective view of a wheelchair lift secured to a plurality of tracks in a vehicle at a side entrance thereof;

FIG. 3 is a cross-sectional view of one embodiment of a track;

FIG. 4 is an end perspective view of a first embodiment of a glider adapted to secure an item to the track;

FIG. 5 is an exploded perspective view of the first embodiment glider securing the item to the track;

FIG. 6 is a perspective view showing the first step of using the first embodiment glider to secure the item to the track;

FIG. 7 is a perspective view showing the second step of using the first embodiment glider to secure the item to the track;

FIG. 8 is a perspective view showing the third step of using the first embodiment glider to secure the item to the track;

FIG. 9 is a perspective view showing the fourth step of using the first embodiment glider to secure the item to the track;

FIG. 10 is a perspective view showing the fifth step of using the first embodiment glider to secure the item to the track;

FIG. 11 is a perspective view showing the sixth step of using the first embodiment glider to secure the item to the track;

FIG. 12 is a perspective view showing the seventh step of using the first embodiment glider to secure the item to the track;

FIG. 13 is a cross-sectional view showing the seventh step of using the first embodiment glider to secure the item to the track;

FIG. 14 is an exploded perspective view of a second embodiment glider securing the item to the track;

FIG. 15 is a perspective view showing the first step of using the second embodiment glider to secure the item to the track;

FIG. 16 is a perspective view showing the second step of using the second embodiment glider to secure the item to the track; and,

FIG. 17 is an exploded perspective view of a third embodiment glider securing the item to the track.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

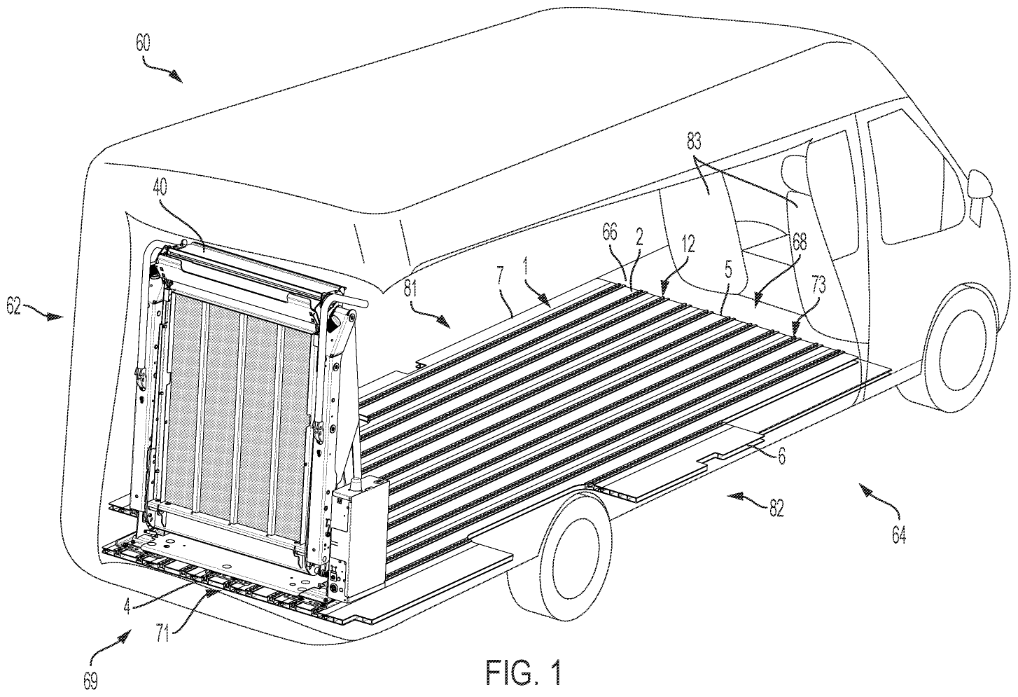

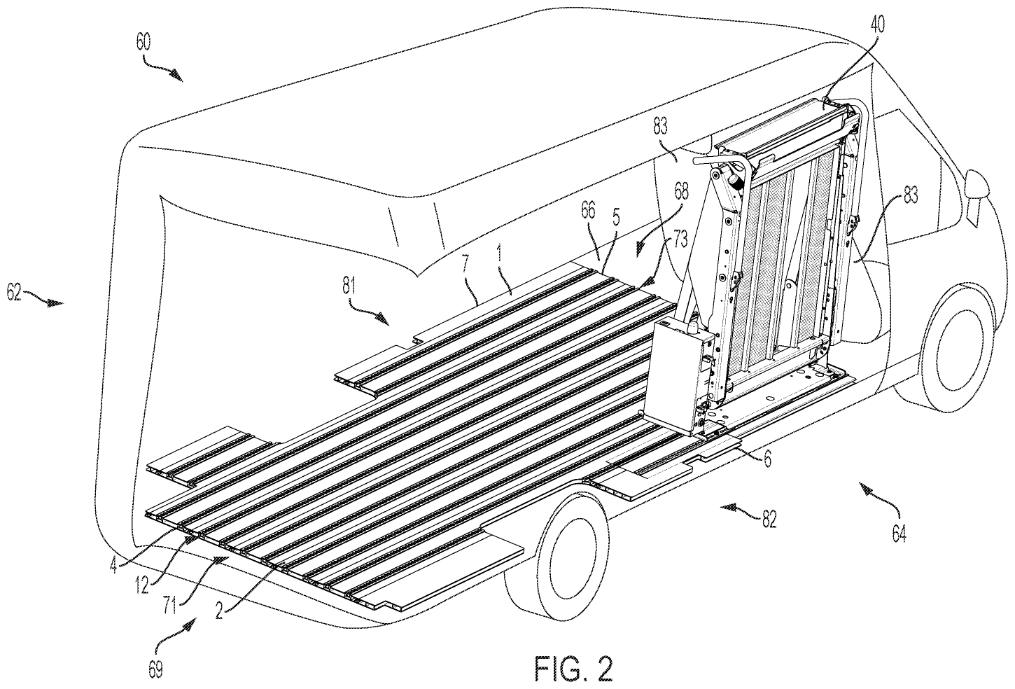

FIGS. 1 and 2 illustrate typical layouts for OEM vehicles (e.g., vans) that have been modified to permit access by a physically limited passenger. In FIG. 1, a wheelchair lift 40 is installed adjacent a rear entrance 62 of a vehicle 60 to permit rear entry. In FIG. 2, the wheelchair lift 40 is installed adjacent a side entrance 64 of a vehicle 60 to permit side entry. In both cases, the wheelchair lift 40 is mounted to a plurality of tracks 12 that are installed on or in the OEM floor 66.

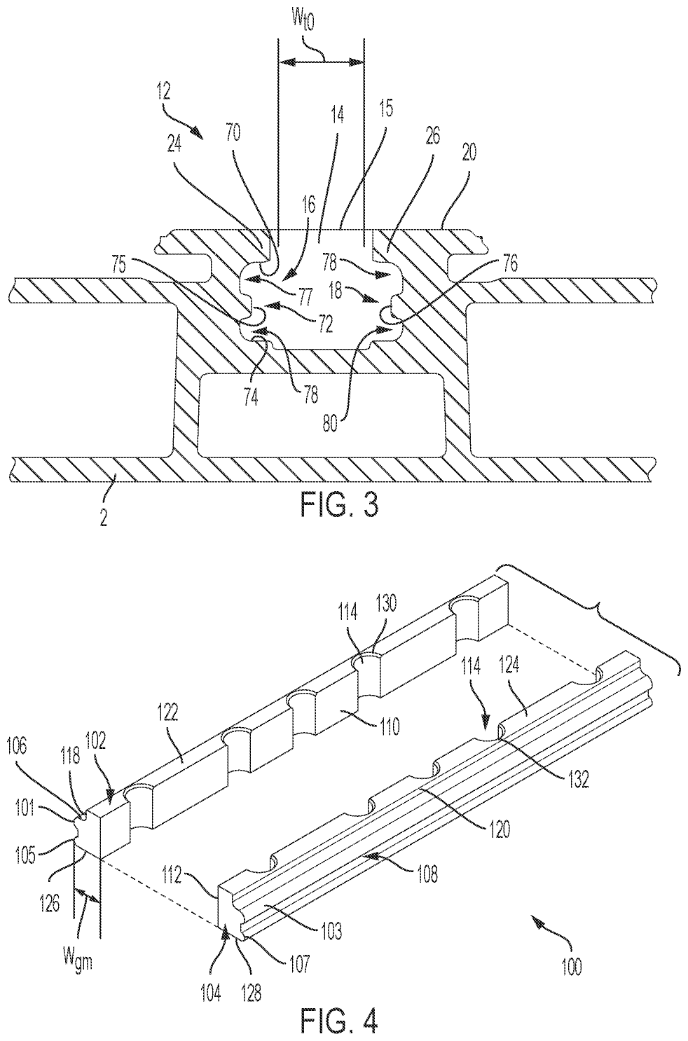

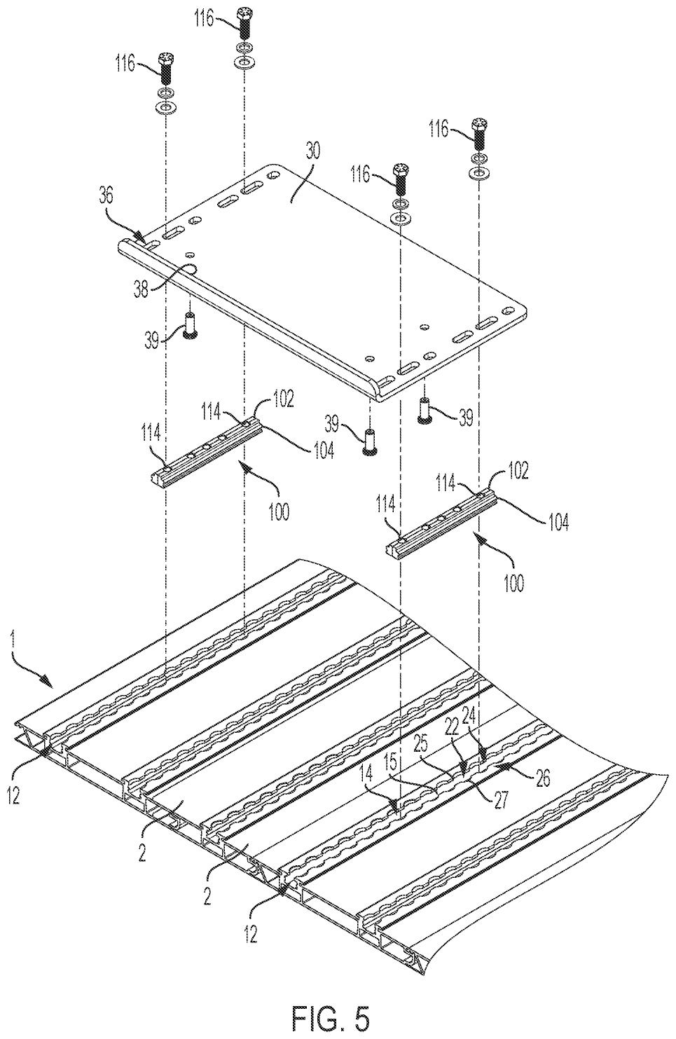

The track 12 may be formed from extruded aluminum or may be machined from bar stock in a generally C-shape. As shown, the track 12 may also be extruded or otherwise made integral to a floor panel 2 that is configured to be glued or mechanically joined at one or both side edges to one or more adjacent floor panels 2. As best seen in FIG. 3, the track 12 may include a channel 14 with a top opening 15 that extends lengthwise along the top surface 20 of the track 12. The channel 14 may be provided with undercuts 16, 18 extending under the top surface 20 of the track to either side of the top opening 15 of the channel 14 to define inwardly directed upper lips 24, 26. The undercuts 24, 26 may each further define a top wall 70, a side wall 72, and a bottom wall 74. In some embodiments, one or both of the side walls 72 may include surface contours, such as the protrusion (or inwardly directed lower lips) 75, 76 that creates an upper undercut region 77, 78 and a lower undercut region 79, 80. As best seen in FIG. 5, a series of equally spaced holes 22 can be drilled or formed through the inwardly directed upper lips 24, 26 along the length of the top opening 15 whereby the inwardly directed upper lips 24, 26 include scallops 25, 27 and can be described as “scalloped” along their length. The presence of scallops 25, 27 allows various fittings known in the art (e.g., those described in U.S. Pat. No. 7,637,705, incorporated herein by reference) to mate with the track 12, although scallops 25, 27 are not required (but can be present) for the track fitting embodiments 100, 200, 300 described herein.

In that regard, the track 12 may be of several different types, including but not limited to the L-track style as shown, which includes a series of equally spaced holes 22 (scallops 25, 27) and scalloped inwardly directed lips 24, 26, or may be of a Unistrut-type, which is the same or similar to L-track but does not include holes 22 (scallops 25, 27) or scalloped lips 24, 26. Typically, the track 12 is installed in or on an OEM floor 66 of a vehicle 60 with the length of the track 12 aligned from front 68 to rear 69 of the vehicle. However, the track 12 may be aligned from left side 81 to right side 82 in or on the OEM vehicle floor 66, or may be installed on other surfaces, including those oriented vertically, upside down, or at any other angle and direction. While it is contemplated that track fittings 100, 200, 300 can be used with track mounted in any configuration, for the purpose of describing the embodiments it is assumed that the track fittings 100, 200, 300 are installed in a floor-mounted track 12 as shown, whereby the term horizontal is used in the description to refer to a direction or a plane that is generally parallel to the top surface 20 of the track 12 and the term vertical is used in the description to refer to a direction or a plane that is generally perpendicular to the top surface 20 of the track 12. Additionally, the term longitudinal refers to a direction extending along the length of the track 12, while the term lateral refers to a direction extending perpendicular to the length of the track 12 but in the same horizontal plane as the longitudinal direction.

As shown, the tracks 12 may be integrated into an extruded aluminum floor 1 that may be installed above the OEM floor 66 of the vehicle 60. The floor 1 may cover the entire OEM floor 66 or as shown, only a portion of the OEM floor 66. As illustrated, the floor 1 extends from a rear end 4 adjacent the rear entrance 62 of the vehicle 60 to a front end 5 adjacent the back side of the front seats 83 of the vehicle 60. A right side 6 of the floor 1 may be adjacent a right side 82 (and right side door) of the vehicle 60, while a left side 7 of the floor 1 may be adjacent a left side 81 (and left side door) of the vehicle. For side entry, the wheelchair lift 40 may be installed on either the right side 6 of the floor 1, as shown in FIG. 2, or the left side 7 of the floor 1 (not shown), depending upon which side of the vehicle is the curb side of the vehicle 60 (right side 82 in the US, left side 81 in the UK).

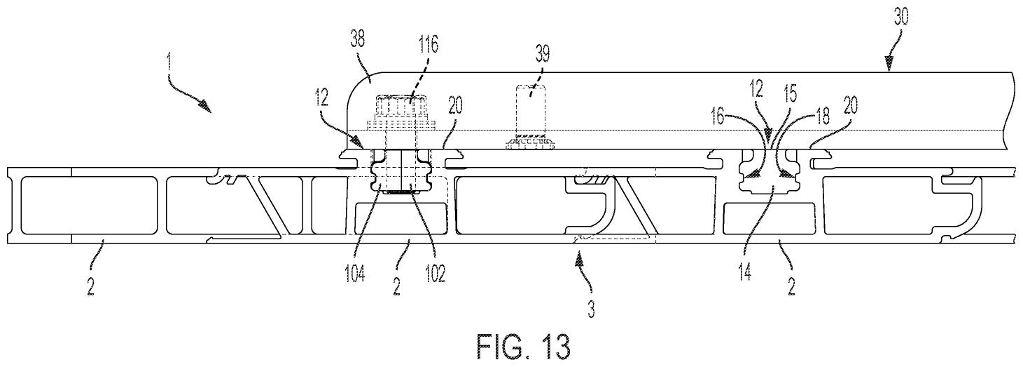

The floor 1 may comprise a plurality of the floor panels 2 (see, e.g., FIG. 13) that are connected to each other at their sides via mechanical connectors 3 (snaps, etc.), welding, gluing, or other means and methods. The panels 2 can be assembled (connected together) in the vehicle 60, one panel 2 at a time. Alternatively, the panels 2 can be fully or partially assembled (connected together) outside of the vehicle 60 in one or more sections (for example, two halves). The section or sections can then be inserted into the vehicle 60 and, if needed, the multiple sections can be connected together inside of the vehicle 60. At least some of the panels 2 may include the integrated track 12. The integrated track 12 can be formed into the panels 2 during the extrusion process, or can be a separate component that is attached to the top surface of the panel 2 after the extrusion process. Fully assembled, the floor 1 may have a plurality of parallel tracks 12 that extend parallel to the length of the vehicle 60, as shown. In other embodiments, the tracks 12 may extend side to side across the width of the vehicle 60. In yet other embodiments, the vehicle may include a plurality of tracks 12 that are aligned transversely to each other, one or more along the length of the vehicle and one or more aligned side to side. In any case, the tracks 12 (i.e., the channels 14) not only have a top opening 15, but also have openings at both ends. For example, in the embodiment shown in FIGS. 1-2, the channels 14 are open at both the front end 5 and rear end 4 of the floor. Obviously, the open front end 73 and open rear end 71 of the channels 14 can be made closed or inaccessible by plugs, threshold plates, or other structures.

While previously thru bolted to the OEM floor 66, it is contemplated herein that the wheelchair lift 40 can be mounted to track 12 without disturbing the vehicle structure, using elongated gliders (also referred to herein as fittings or track fittings) 100, 200, 300 that are configured to help distribute the cantilever loads of the lift 40 to the track 12. The gliders 100, 200, 300 are particularly useful for electric vehicles as most cannot accommodate thru-floor mounting due to battery placement. The gliders can take a multi-piece form (glider 100), which permits top-down installation, or a single piece form (gliders 200, 300), which must be inserted into one of the open ends 71, 73 of the channel 14 and slid down the length of the track 12 to the intended installation location.

Referring now to FIGS. 4, 5, 12 and 13 a multi-piece glider 100 may be used to secure an item 30 to a longitudinal track 12. In some ways, the glider 100 is similar to the “foot 225” described in U.S. Patent Application No. US 2020/0155386 A1 (“the '386 Application,” incorporated herein by reference) for securing seat legs. However, the foot 225 of the '386 Application is inferior to the glider 100 in that it cannot be inserted top down through the top opening 15 of the channel 14. Instead, it must be installed through an open end 71, 73 of the track, typically at the rear entrance 62 of the vehicle 60, and slid down the length of the track 12 to a desired location. In that regard, with the foot 225 of the '386 Application, floor mounted equipment (e.g., seats) usually must be attached to the floor 1 in a front 5 to back 4 order. Moreover, rearranging equipment installed on the floor 1 can be difficult and may require disconnecting and reinstalling at least some and perhaps all of the floor-mounted equipment.

In contrast, the glider 100 comprises a plurality of pieces that cooperate to secure the item 30 to the track and are each sized or configured to enable top-down insertion. As one example, the glider 100 may comprise a first glider member 102 and a second glider member 104, where each may have a width W_{gm} that is less than the width Wₜₒ of the top opening 15 of the channel 14. In that regard, the glider members 102, 104 can be independently dropped into the channel 14 from above, through the top opening 5, rather than needing to be inserted through an open end 71, 73 of the track 12. In other embodiments, the width W_{gm} of the glider members 102, 104 can be greater than the width Wₜₒ of the top opening 15 of the channel 14 and have dimensions and shape (e.g., an angled or L-shape) that allows insertion by angling (e.g., by inserting flange member 106, 108 into the top opening 15 of the channel 14 first, and then rotating the rest of the glider member 102, 104 into the channel 14).

The first glider member 102 may be a mirror image of the second glider member 104 about a vertical plane (the mirror plane) that is parallel to a longitudinal axis of the glider 100. The first glider member 102 and the second glider member may additionally be identical, as shown, as least prior to a threading manufacturing step described below. In that regard, the first glider member 102 may include a first flange member 106 and a first face 110 disposed opposite sides thereof, while the second glider member similarly may include a second flange member 108 and a second face 112 disposed on opposite sides thereof. In a use configuration (e.g., FIG. 13), the glider members 102, 103 can be oriented with the first face 110 adjacent and at least approximately abutting the second face 112 (there may be a small gap between the two faces 110, 112), where the flange members 106 and 108 project in laterally opposite directions for receipt and engagement in the undercuts 16, 18, respectively, of track 12. In some embodiments, each of the glider members 102, 104 may include neck portions 118, 120 that are disposed between the flange members 106, 108 and faces 110, 112 and extend upward from the flange members 106, 108, whereby a top surface 122, 124 may be approximately equal to (including slightly below or slightly above) the elevation of the top surface 20 of the track 12 (see e.g., FIG. 13). In other embodiments, the top surface 122, 124 (or portions thereof) may be disposed below the top surface 20 of the track, at an elevation between the top surface 20 and the top wall 70 of the undercuts 16, 18, or even approximately equal to or below the elevation of the top wall 70.

Ideally, although not required, the flange members 106, 108 extend along the entire length of the glider members 102, 104, respectively, and the surfaces and cross-section of flange members 106, 108 closely corresponds to or matches undercuts 16, 18. As shown, flange members 106, 108 may include two outwardly projecting flange portions (which may be characterized as wings): upper flange portion 101, 103 and lower flange portion 105, 107. Upper flange portions 101, 103 may be corresponding shaped with and received and engaged in upper undercut regions 77, 78, while lower flange portions 105, 107 may be corresponding shaped with and received and engaged in lower undercut regions 79, 80. This configuration provides additional strength as compared to alternative embodiments contemplated herein, where the flange members 106, 108 may each only include one outwardly projecting portion. More particularly, the multi-flange portion configuration will allow the glider 100 to resist vertical pull forces better. When the glider 100 is subjected to an upward pull force, not only will the upper flange portion 101, 103 engage with the inwardly directed lips 24, 26, the lower flange portion 105, 107 will engage with projections 75, 76. In that regard, the strength of the connection between the glider 100 and the track 12 is not limited to the strength of a single flange portion 101, 103 and the inwardly directed lips 24, 26, but instead is the sum of the strengths of multiple flange portions 101, 103, 105, 107, the inwardly directed lips 24, 26, and the projections 75, 76.

The flange members 106, 108 (including the undersides 126, 128 of the gliders 102, 104) may include grooves, burrs, projections, surface roughness or engagement members that create frictional interference with the surfaces of the channel 14 (beyond those that exist when embodied as smooth surfaces), whereby the frictional interference will resist longitudinal sliding of glider 100 along the length of the channel 14. Similarly, along the mirror plane, the gliders 102, 104 have opposing surfaces or faces 110, 112 that may be planar and smooth, as shown, or may by non-planar and/or have grooves, burrs, projections, surface roughness, or other engagement members that resist displacement of one glider member 102, 104 relative to the other (in any direction, including longitudinally and vertically).

Each of the glider members 102, 104 may further include one or more partial holes 130, 132 that combine to form substantially complete holes 114 when the two glider members 102, 104 are brought together at their faces 110, 112. In that regard, the glider 100 when viewed as an assembly includes one or more vertical holes 114 distributed along the length of the glider 100 that are adapted to receive a bolt, peg, or other similar fastener 116. One or more of the holes 114 may be threaded for engagement with the fastener 116, which includes corresponding threads. The length of the glider 100 may be selected based on the strength required for its application, the number of gliders 100 used, etc. The holes 114 may be disposed in specific locations to correspond with the bolting pattern of the item 30 being connected thereto.

Any number of manufacturing processes can be used to make the glider 100. In one such process, the glider 100 can be extruded as a single piece, cut to length, and cut along the mirror line to form glider members 102, 104. The two cuts (to length and along mirror line) can be made in either order. In another process, the glider members 102, 104 can be extruded separately (in some cases, using the same extrusion given they may be mirror images/identical). In yet another process, the glider members 102, 104 can be cast or mechanically formed or milled from bar stock. Regardless of what process is used, to ensure precise alignment of the partial holes 130, 132 (which form holes 114 that span the two glider members 102, 104), the glider members 102, 104 may then be clamped (or otherwise fixed or adhered together) together to permit partial holes 130, 132 to be drilled in both glider members 102, 104 simultaneously. At least some of the holes 114 may also be threaded while the glider members 102, 104 are fixed together to ensure that the threads of partial holes 130, 132 are aligned properly.

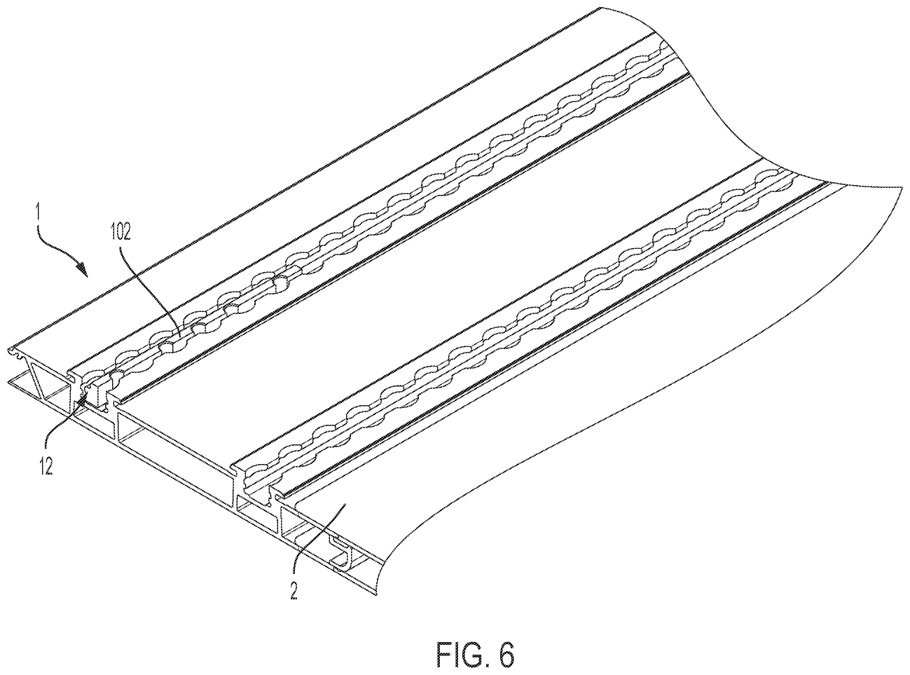

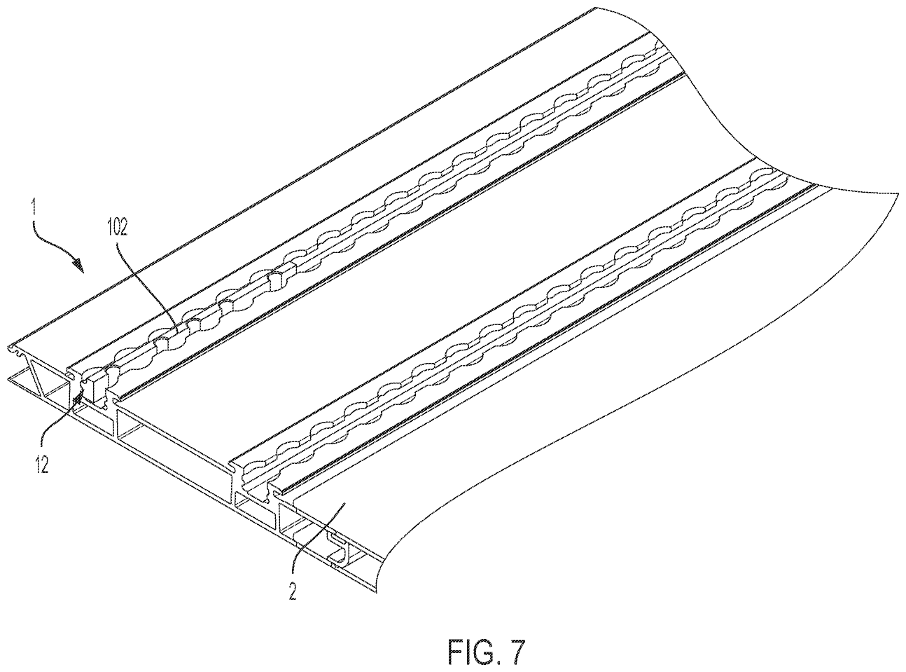

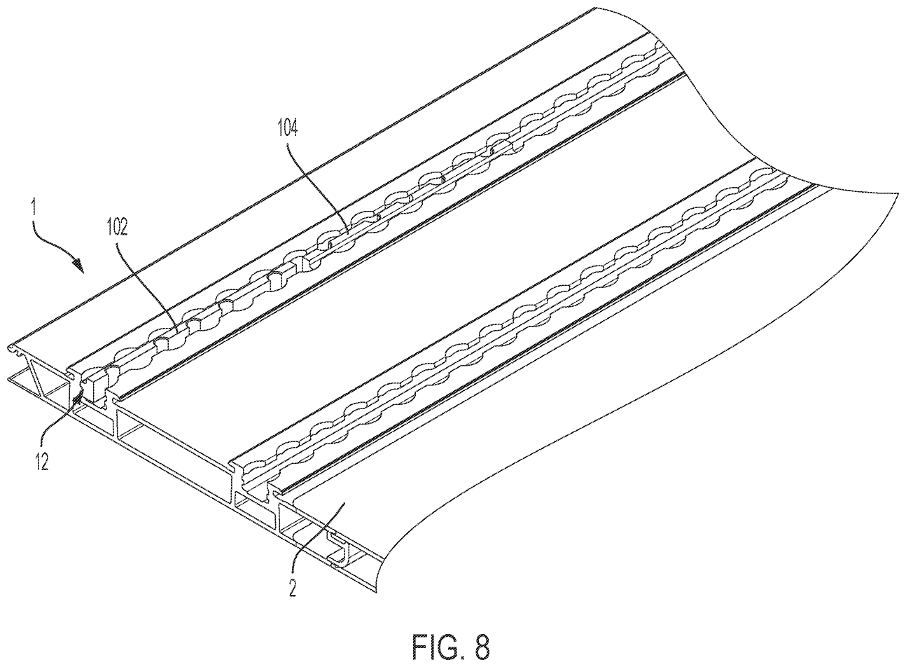

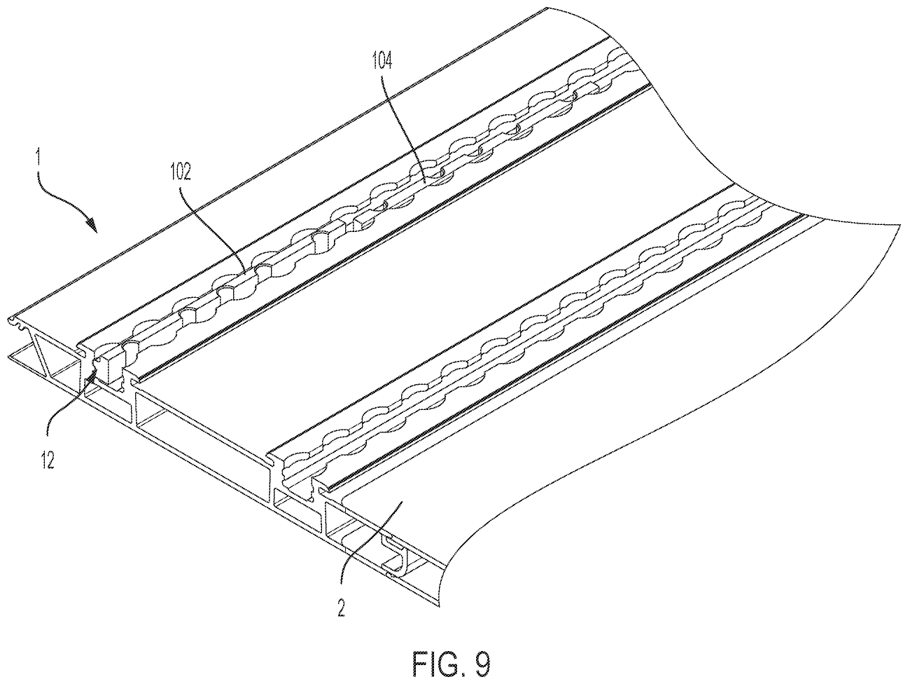

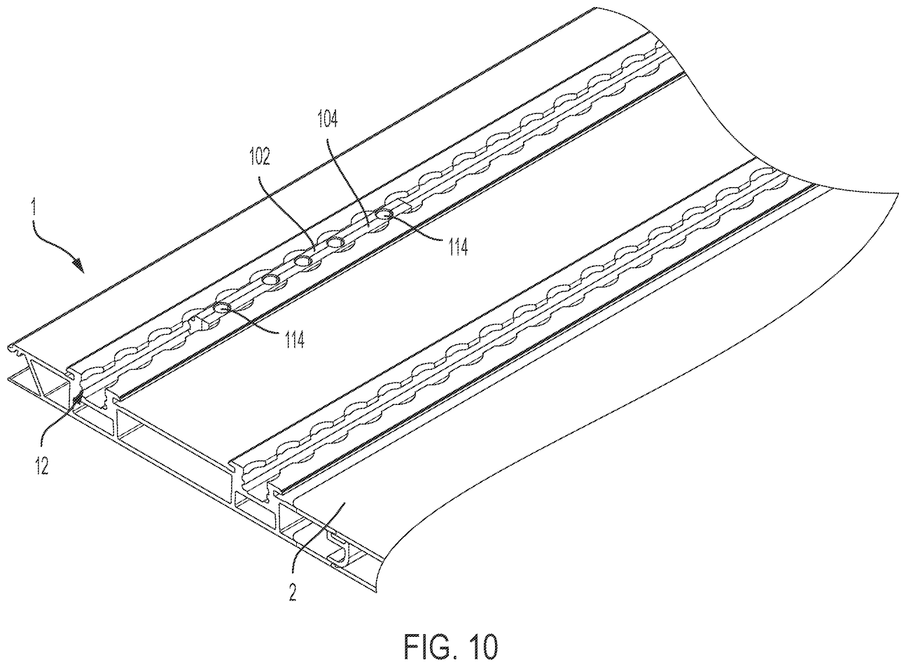

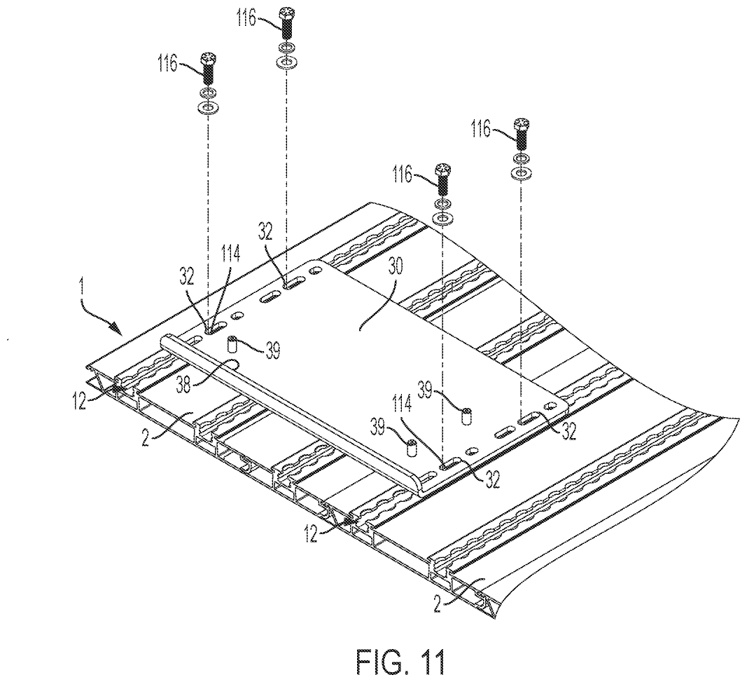

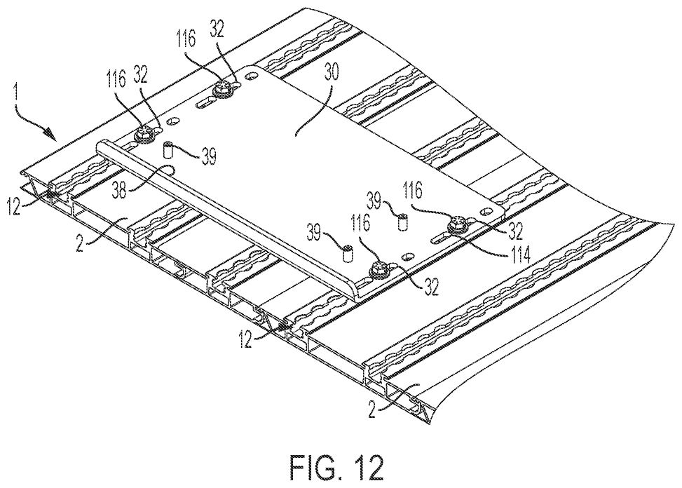

Turning now primarily to FIGS. 5-13, one method for using the split glider 100 to secure an item 30 to a track 12 is demonstrated. In the first step shown in FIG. 5, at least one track 12, at least one split glider 100, at least one item 30, and at least one fastener 116 is provided. In the next step shown in FIG. 6, the first glider member 102 may be inserted top-down through a top opening 15 of the track 12, whereby the first glider member 102 may be disposed centrally in channel 14 between the two undercuts 16, 18. In the next step shown in FIG. 7, the first glider member 102 may be shifted laterally toward the first undercut 16, whereby the first flange member 106 will be received in the first undercut 16 and the first face 110 will be disposed approximately at the center line of the channel 14. In the next step shown in FIG. 8, the second glider member 104 may be inserted top-down through the top opening 15 of the track, whereby the second glider member 104 may be disposed centrally in channel 14 between the two undercuts 16, 18 and longitudinally displaced from the first glider member 102. In the next step shown in FIG. 9, the second glider member 104 may be shifted laterally (in the opposite direction as the first glider member 102) toward the second undercut 18, whereby the second flange member 108 will be received in the second undercut 18 and the second face 112 will be disposed approximately at the center line of the channel 14. At this stage of assembly, the first glider member 102 and the second glider member 104 are still longitudinally displaced from each other (i.e., lined up essentially end to end and possibly with the ends spaced apart a distance; not next to each other). In the next step shown in FIG. 10, one or both of the first and second glider members 102, 104 can be slid longitudinally in channel 14 until they are disposed with their faces 110, 112 adjacent and approximately abutting each other and with their partial holes 130, 132 aligned to form a substantially complete hole 114. In the next step shown in FIG. 11, the item 30 can be placed on the top surface 20 of the track 12 with at least one aperture 32 of the item 30 aligned with at least one hole 114 of the glider 100. In the next (and possibly final depending on the nature of the item 30) step shown in FIGS. 12 and 13, the fastener(s) 116 may be inserted through the aperture 32 and engaged with the hole 114 in the glider 100 to lock the item 30 to the track 12.

It is contemplated that the glider 100 may be used in applications where it may be easy or convenient to insert the glider 100 through the ends 4, 5 of the channels 14 (for example, when a wheelchair lift 40 is installed at a rear entrance 62 as shown in FIG. 1). In that regard, the two halves (glider members) 102, 104 may be provided with a frangible connector connecting the two halves together at or adjacent their opposing surfaces 110, 112. For end-insertion applications, the user can leave the two glider members 102, 104 connected. For top-down-insertion applications, the user can break apart or otherwise separate the two glider members 102, 104. The frangible connector between the glider members 102, 104 can be made using tape, glue or other adhesive, a weld, or a thin connecting piece or wall of material formed during the manufacturing process (for example, leaving a thin section of aluminum material connecting the two during the cutting process along the mirror plane).

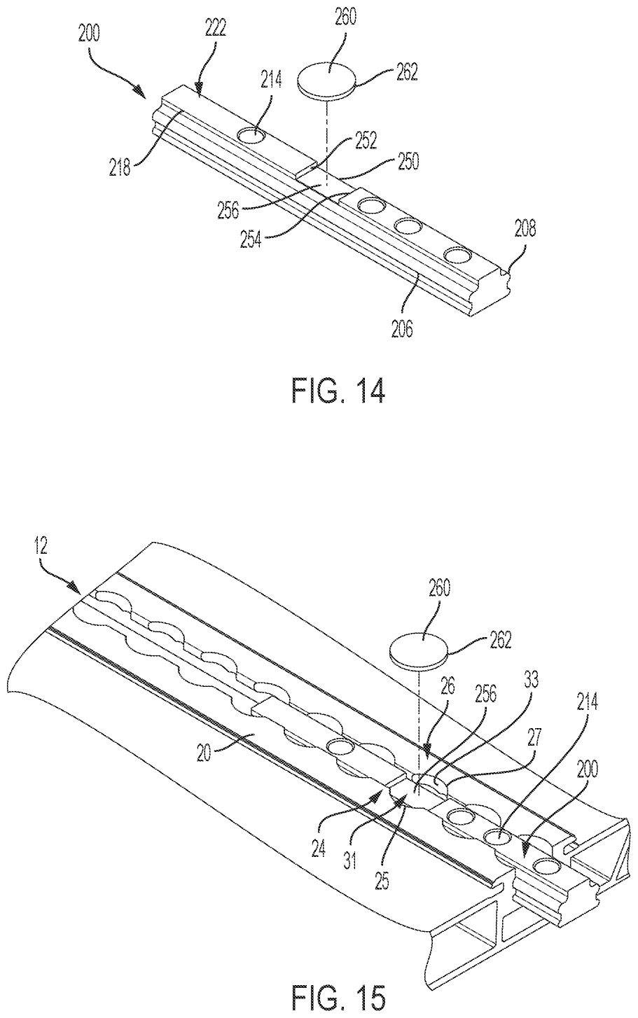

Referring now to FIGS. 14-16, a second embodiment of a glider 200 may be used to secure the item 30 to a longitudinal track 12. In most respects, the glider 200 can be configured using any of the same combinations of features as the first embodiment glider 100, except glider 200 is depicted as a single piece. Like glider 100, the glider 200 includes: flange members 206, 208 that extend laterally outward in opposite directions for receipt and engagement in undercuts 16, 18 in the track 12; at least one hole 214 extending through the top surface 222; and a neck portion 218. The main difference between gliders 100, 200 is that the glider 200 includes an interface 250 for engaging with a locking member 260 to prevent the glider 200 from sliding longitudinally down the track under load. In this embodiment, interface 250 is a recessed area (or pocket) 250 in the neck portion 218 of glider 200. The recessed area 250 may be configured to receive and may be correspondingly shaped with locking member 260. The recessed area 250 may be defined by at least one shoulder (or step or boundary wall) 252, 254 that are configured to engage with locking member 260 (for example, with a portion of a perimeter 262 thereof) by interference to prevent the glider 200 from moving longitudinally relative to the locking member 260 and, as explained below, to prevent the glider 200 from moving longitudinally relative to the track 12.

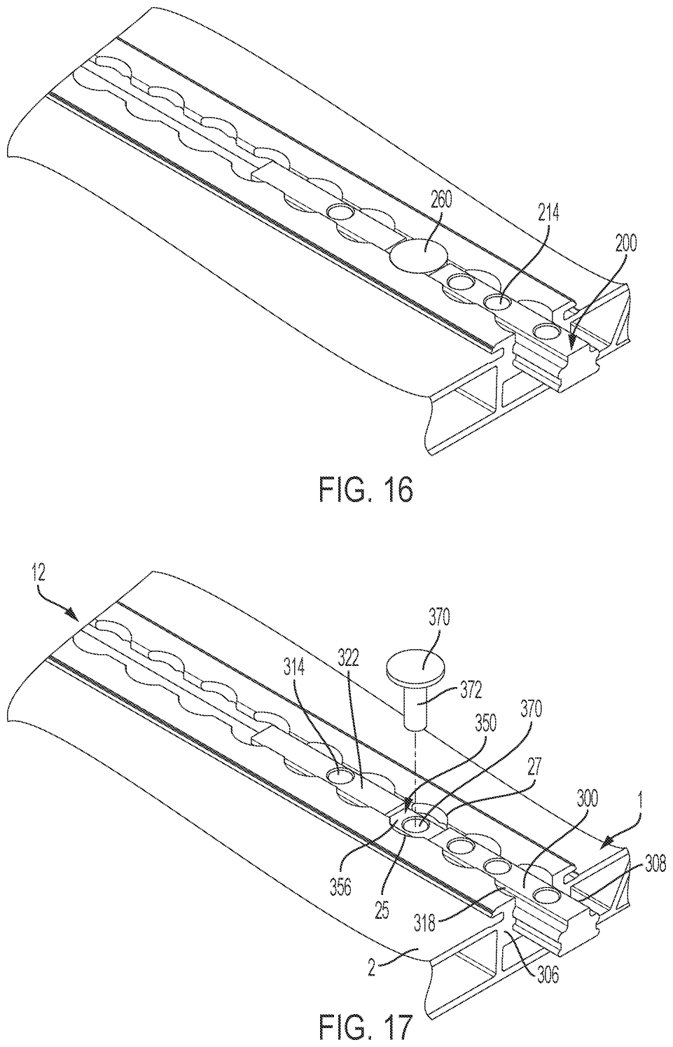

More particularly, the recessed area 250 of the glider 200 may be aligned underneath the scallops 25, 26 in the upper lips 24, 26 as shown in FIG. 15. In this configuration, the floor 256 of recessed area 250 will be disposed at an elevation below the top surface 20 of the track 12 to expose at least a portion of the inner edges 31, 33 of scallops 25, 26. At this point, the locking member 260 can be inserted in between the scallops 25, 26 where it will rest in the recessed area 250 on top of the floor 256, as shown in FIG. 16. In a next step, the item 30 can be secured on top of the track 12 by bolting through at least one of the holes 214, which holds locking member 260 between the scallops 25, 26 and in the recessed area 250.

Notably, the locking member 260 has a thickness greater than the depth of the recessed area 250, whereby a portion of the perimeter 262 of the locking member 260 will rest adjacent at least one of the shoulders 252, 254 and another portion of the perimeter 262 will rest adjacent at least one of the scallops 25, 26. By virtue of engagement by interference with at least one of the scallops 25, 26, the locking member 260 cannot slide longitudinally down a length of the track. And, by virtue of the recessed area 250/shoulders 252, 254 engaging by interference with the locking member 260, the glider 200 also cannot slide longitudinally down a length of the track.

In some embodiments, the locking member 260 may have a height approximately equal to the distance between the floor 256 of the recessed area 250 and the top surface 20 of the track. In some embodiments, the floor 256 may have an elevation approximately equal to or below the top walls 70 of undercuts 16, 18. In some embodiments, the locking member 260 may have a shape that corresponds to the shape of the scallops 25, 26, for instance the circular/cylindrical shape shown.

Referring now to FIG. 17, a third embodiment of a glider 300 may be used to secure the item 30 to a longitudinal track 12. In most respects, the glider 300 can be configured using any of the same combinations of features as the first and second embodiment gliders 100, 200, except glider 300 is depicted as a single piece like glider 200. Like gliders 100, 200, the glider 300 includes: flange members 306, 308 that extend laterally outward in opposite directions for receipt and engagement in undercuts 16, 18 in the track 12; at least one hole 314 extending through the top surface 322; and a neck portion 318. And, like glider 200, glider 300 includes a first interface in the form of recessed area 350. The main difference between gliders 200, 300 is that the glider 300 includes an additional interface 370 for additional engagement with a locking member 360 to prevent the glider 300 from sliding longitudinally down the track under load. In this embodiment, interface 370 is a hole 370 through the floor 356 of the recessed area 350, where hole 370 is configured to receive a stud 372 that depends from the locking member 370. In some embodiments, the hole 370 and stud 372 may be correspondingly threaded to retain the locking member 370 in recessed area 350. While the third embodiment glider 300 includes two interfaces for preventing longitudinal sliding of the glider 300 (i.e., recessed area 350 and hole 370), it is contemplated that the second interface (hole 370) can be used independently from first interface (recessed area 350). In such an embodiment, the height of the neck portion 318 could be reduced whereby the entire top surface 322 could be disposed at an elevation below the top surface 20 of the track, and preferably at or about the elevation of the top wall 70. The hole 370 could be disposed anywhere along the length of the glider 300. In one embodiment, the glider 300 would be slid longitudinally in the track until the hole 370 was centered underneath the scallops 25, 27. Then, the locking member 360 would be inserted between the scallops 25, 27 with the stud 372 disposed inside the hole 370. By virtue of engagement by interference with at least one of the scallops 25, 26, the locking member 360 cannot slide longitudinally down a length of the track. And, by virtue of the hole 370 engaging by interference with the stud 372 of the locking member 360, the glider 300 also cannot slide longitudinally down a length of the track.

While glider 100 is depicted as a multi-piece glider, it is contemplated that it could take form as a single-piece glider. For example, the glider 100 in such an alternative embodiment could be manufactured using the steps described above, minus the step of cutting it along a mirror line. Moreover, while gliders 200, 300 are depicted as single-piece gliders, it is contemplated that they could take form as multi-piece gliders. For example, the gliders 200, 300 in such alternative embodiments could be manufactured using an extrusion, casting or milling process, following by cutting to length, plus the steps of cutting them along a mirror line (or extruding them in two separate pieces) and fixing the two pieces together before drilling and/or threading holes 214, 314, and forming, milling, drilling, and/or threading at least one of the interfaces 250, 350, 370.

Notably, the gliders 100, 200, 300 have application securing any number of structures to the track 12, including seats, wheelchair ramps, wheelchair securements, occupant restraints, etc. In this case, glider 100 is shown securing item 30, an adapter plate 30 for securing a wheelchair lift 40 in the vehicle. More particularly, a plurality of gliders 100 secures a plurality of adapter plates 30, which collectively support the wheelchair lift 40.

The adapter plate 30 may include one or more connectors that engage with and anchor the wheelchair lift 40. In this case, the connectors take the form of a plurality of threaded studs 39 that extend from the top surface of the plate 30 in an upwardly direction. The studs 39 may be arranged in a pattern corresponding to the bolting pattern of the wheelchair lift 40 (i.e., the pattern of apertures in the base or other supporting structure of the wheelchair lift 40). In some embodiments, the studs 39 may all be disposed between the rows 34, 36 of apertures 32. The threaded studs 39 are configured to receive nuts or other fasteners to secure the wheelchair lift 40 to the plate 30. The adapter plate 30 may include one or more stiffening ribs 38 to resist bending moments resulting from upward forces imparted on studs 39 by wheelchair lift 40. In this case, rib 38 is an upwardly bent edge of the adapter plate 30 that extends in a direction transverse to the rows 34, 36 and spans at least the distance between the rows 34, 36 (as well as the distance between the studs 39 which in some embodiments are between the rows 34, 36). In other embodiments, the ribs may be separate components that are welded to the adapter plate 30, could be aligned in other directions than shown, and could be shorter, longer, or segmented.

As discussed above and shown in FIGS. 5-13, each adapter plate 30 includes a plurality of apertures 32 that are adapted to receive fasteners 116 therethrough for securing each plate 30 to the glider 100 (and thereby the track 12, whereby inwardly directed lips 24, 26 are disposed and may be compressed between flanges 16, 18 and the underside of plate 30). With reference specifically to FIG. 5, the apertures 32 may be arranged in a plurality of rows, in this case two rows 34, 36. The rows 34, 36 may be spaced apart a distance that corresponds to a distance between two or more parallel tracks 12. Within each row 34, 36, at least two apertures 32 may be spaced apart a distance that also corresponds to the distance between two or more parallel tracks 12. In that regard, in some embodiments, the same adapter plate 30 can be mounted to the tracks 12 in multiple orientations: with the length of the adapter plate 30 aligned in the lateral direction as shown in FIGS. 2 and 5-13, and with the adapter plate turned 90° where the length of the adapter plate 30 is aligned in the longitudinal direction as shown in FIG. 1.

In other embodiments, the apertures 32 may be arranged in a pattern on the adapter plate 30 that permits the same adapter plate 30 to be compatible for use in both the rear entry position of FIG. 1 and the side entry position of FIG. 2. In that respect, use of a first set of apertures 32 in the adapter plate 30 to secure the plate near the rear doors will place threaded studs 39 in an appropriate position for securing wheelchair lift 40 in the rear entry position. Similarly, use of a second set of apertures 32 in the adapter plate 30 to secure the plate near the side door will place threaded studs 39 in an appropriate position for securing wheelchair lift in the side entry position. In some cases, the first set of apertures will not find identity with the second set of apertures (the sets of apertures will be different), although there may be some overlap of individual apertures (some apertures may be part of both sets).

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A track fitting for securing an item to a track, the track being defined by a channel having a first undercut and a second undercut on opposite sides of a top opening, the track fitting comprising:
a first fitting member having a first flange and a first face on opposite sides thereof, and a first partial hole on the first face; and,
a second fitting member having a second flange and a second face on opposite sides thereof and a second partial hole on the second face.

2. The track fitting of claim 1, wherein:
the first fitting member and second fitting member are each configured for independent top down insertion into the channel through the top opening, whereby the first flange can be inserted in the first undercut, the second flange can be inserted in the second undercut, and the first face can be disposed adjacent and generally parallel to the second face;
the first partial hole and the second partial hole define a substantially complete hole for receiving a fastener when the first face is aligned adjacent and generally parallel to the second face.

3. The track fitting of claim 1, wherein the fastener is a threaded fastener and the first partial hole and the second partial hole comprise a pair of threaded partial holes that are configured to receive the threaded fastener when aligned.

4. The track fitting of claim 2, wherein the fastener is a threaded fastener and the first partial hole and the second partial hole comprise a pair of threaded partial holes that are configured to receive the threaded fastener when aligned.

5. The track fitting of claim 1, wherein the first fitting member comprises a plurality of first partial holes spaced along a length of the first fitting member, the second fitting member comprises a plurality of second partial holes spaced along a length of the second fitting member, and the plurality of first partial holes and the plurality of second partial holes define a plurality of substantially complete holes for receiving a plurality of fasteners when the first face is aligned adjacent and generally parallel to the second face.

6. The track fitting of claim 4, wherein the first fitting member comprises a plurality of first partial holes spaced along a length of the first fitting member, the second fitting member comprises a plurality of second partial holes spaced along a length of the second fitting member, and the plurality of first partial holes and the plurality of second partial holes define a plurality of substantially complete holes for receiving a plurality of fasteners when the first face is aligned adjacent and generally parallel to the second face.

7. The track fitting of claim 1, wherein the first flange is disposed along an entire length of the first fitting member and the second flange is disposed along an entire length of the second fitting member.

8. The track fitting of claim 6, wherein the first flange is disposed along an entire length of the first fitting member and the second flange is disposed along an entire length of the second fitting member.

9. The track fitting of claim 1 further comprising a frangible connector connecting the first fitting member to the second fitting member with the first face aligned adjacent and generally parallel to the second face.

10. The track fitting of claim 9, wherein the frangible connector comprises one of an adhesive, a weld, and a tape.

11. The track fitting of claim 9, wherein the frangible connector is formed integral with the first fitting member and the second fitting member.

12. The track fitting of claim 8 further comprising a frangible connector connecting the first fitting member to the second fitting member with the first face aligned adjacent and generally parallel to the second face.

13. The track fitting of claim 1, wherein:
the first partial hole has an axis that is generally parallel to the first face and generally transverse to a longitudinal direction of the track fitting; and,
the second partial hole has an axis that is generally parallel to the second face and generally transverse to a longitudinal direction of the track fitting.

14. The track fitting of claim 8, wherein:
the first partial hole has an axis that is generally parallel to the first face and generally transverse to a longitudinal direction of the track fitting; and,
the second partial hole has an axis that is generally parallel to the second face and generally transverse to a longitudinal direction of the track fitting.

15. The track fitting of claim 1 further comprising a locking member, wherein:
the top opening is defined by a pair of opposing lips each having a plurality of scallops;
a first portion of the locking member engages an opposing pair of the plurality of scallops and a second portion of the locking member engages with at least one of the first fitting member and the second fitting member to prevent the at least one of the first fitting member and the second fitting member from moving in a longitudinal direction relative to the track.

16. The track fitting of claim 1, wherein the first flange includes an upper flange portion and a lower flange portion for engagement on opposite sides of an inwardly directed projection in a side wall of the first undercut of the track, wherein the upper flange portion is received in an upper undercut region while the lower flange portion is received in a lower undercut region.

17. A method for using the track fitting of claim 1, the method comprising the steps of:
inserting the first fitting member in the channel through the top opening;
sliding the first fitting member in a first lateral direction whereby the first flange is disposed in the first undercut;
inserting the second fitting member in the channel through the top opening, whereby the second fitting member is laterally displaced from the first fitting member;
sliding the second fitting member in a second lateral direction whereby the second flange is disposed in the second undercut, the second lateral direction being opposite of the first lateral direction;
sliding one or both of the first fitting member and the second fitting member until the first face is adjacent the second face and the first partial hole is aligned with the second partial hole, whereby the first partial hole and the second partial hole for a substantially complete hole; and,
inserting a fastener into the substantially complete hole.

18. A method for manufacturing the track fitting of claim 1, the method comprising the steps of:
providing the first fitting member and the second fitting member without the first partial hole and the second partial hole;
fixing the first fitting member to the second fitting member with the first face adjacent the second face; and,
drilling a hole in a top surface of the first fitting member and the second fitting member to simultaneously form the first partial hole in the first fitting member and the second partial hole in the second fitting member.

19. The method of claim 18, further comprising the step of threading the hole while the first fitting member is still fixed to the second fitting member.
